(19) United States
(12) Patent Application Publication
(10) Pub. No.: US 2025/0267109 A1
(43) Pub. Date: Aug. 21, 2025

(54) HANDLING ERROR CASES IN U2U SIDELINK RELAY NETWORKS

(71) Applicant: SAMSUNG ELECTRONICS CO., LTD., Suwon-si (KR)

(72) Inventors: Milos TESANOVIC, Staines (GB); Hyunjeong KANG, Suwon-si (KR)

(21) Appl. No.: 19/054,145

(22) Filed: Feb. 14, 2025

(30) Foreign Application Priority Data
Feb. 15, 2024 (GB) 2402148.7
Feb. 16, 2024 (GB) 2402235.2
Dec. 12, 2024 (GB) 2418270.1

(51) Int. Cl. H04L 49/55; H04W 72/25

(52) U.S. Cl. CPC H04L 49/557; H04W 72/25

(57) ABSTRACT

The disclosure relates to a 5G or 6G communication system for supporting a higher data transmission rate. A method performed by a first UE in a wireless communication system includes identifying ID information including a local ID of a first remote UE and a local ID of a second remote UE, the local IDs being used for a U2U sidelink in a SRAP; receiving, from a second UE, a data packet with a UE ID, wherein the UE ID includes a destination UE ID indicating a destination of the data packet and a source UE ID indicating a source of the data packet; determining whether the received data packet is an erroneous data packet, based on the identified ID information and the UE ID; and discarding the received data packet, in case that the received data is determined as the erroneous data packet.

### CROSS-REFERENCE TO RELATED APPLICATIONS

This application is based on and claims priority under 35 U.S.C. § 119 to United Kingdom Patent Application No. GB2402148.7 filed on Feb. 15, 2024, United Kingdom Patent Application No. GB2402235.2 filed on Feb. 16, 2024, and United Kingdom Patent Application No. GB2418270.1 filed on Dec. 12, 2024, all filed in the United Kingdom Intellectual Property Office, the disclosures of which are incorporated by reference herein in their entirety.

### BACKGROUND

### 1. Field

The disclosure related to the field of communication, and more particularly, for handling error cases of user-to-user (U2U) sidelink relay networks in a wireless communication system.

### 2. Description of the Related Art

To meet an increasing demand for wireless data communication services since the deployment of the fourth generation (4G) communication system, efforts have been made to develop an improved fifth generation (5G) or pre-5G communication system, referred to as a beyond 4G network or post long term evolution (LTE) system.

5G mobile communication technologies define broad frequency bands such that high transmission rates and new services are possible, and can be implemented not only in sub 6 gigahertz (GHz) bands such as 3.5 GHz, but also in above 6 GHz bands referred to as millimeter wave (mmwave) bands including 28 GHz and 39 GHz bands. In addition, it has been considered to implement 6G mobile communication technologies (referred to as beyond 5G systems) in terahertz bands (e.g., 95 GHz to 3 THz bands) to accomplish transmission rates fifty times faster than 5G mobile communication technologies and ultra-low latencies one-tenth of 5G mobile communication technologies.

Since the beginning of the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmwave, supporting numerologies (e.g., operating multiple subcarrier spacings) for efficiently utilizing mm Wave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul IAB) for providing a node for network service area expansion by supporting a wireless backhaul link and an access link in an integrated manner, mobility enhancement including conditional handover and dual active protocol stack (DAPS) handover, and two-step random access channel for NR (2-step RACH for NR) to simplify random access procedures. There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The Rel-17 3GPP RAN Study Item “Study on NR Sidelink Relay,” completed in 2021 and whose outcome is captured in 3GPP TR 38.836, considered both UE-to-network relay and UE-to-UE relay coverage extension. However, the subsequent Rel-17 normative work in RAN focused exclusively on UE-to-network relay.

UE-to-UE (U2U) relay enables the coverage extension of the sidelink (SL) transmissions between two sidelink UEs, without relying on the use of uplink or downlink. This is especially important for the partial coverage scenario whereby at least one of the UEs involved in relaying (source UE, relay UE, destination UE) is in-coverage, and at least one of the UEs involved in relaying is out-of-coverage. When relay UE is in-coverage, it can access the network via the Uu link. Relaying of data between a source UE and a destination UE can occur once a PC5 link is established between the source UE and UE-to-UE relay, and a PC5 link is established between the destination UE and UE-to-UE relay, and a PC5 link is established between the source UE and the destination UE. Connected to a relay UE there may be multiple destination (DST) remote UEs for a single source (SRC) remote UE, and there may be multiple SRC remote UEs for a single DST remote UE. In Rel-18 there is only one hop; in future releases, there may also be multiple hops/links between a SRC and a DST remote UE.

There are ongoing discussions regarding the U2U sidelink relay, and need to handle errors and misconfigurations that may occur in the U2U remote UE and the U2U relay UE.

### SUMMARY

Various acronyms, abbreviations and definitions used in the present disclosure are defined at the end of this description.

It is an aim of certain examples of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

In accordance with an aspect of the disclosure, a method performed by a first user equipment (UE) in a wireless communication system includes identifying identification (ID) information including a local ID of a first remote UE and a local ID of a second remote UE, wherein the local ID of the first remote UE and the local ID of the second remote UE are used for a user-to-user (U2U) sidelink in a sidelink relay adaptation protocol (SRAP); receiving, from a second UE, a data packet with a UE ID, wherein the UE ID includes a destination (DST) UE ID indicating a destination of the data packet and a source (SRC) UE ID indicating a source of the data packet; determining whether the received data packet is an erroneous data packet, based on the identified ID information and the UE ID; and discarding the received data packet, in case that the received data is determined as the erroneous data packet.

In accordance with an aspect of the disclosure, a first user equipment (UE) in a wireless communication system includes a transceiver; and a processor coupled with the transceiver and configured to: identify identification (ID) information including a local ID of a first remote UE and a local ID of a second remote UE, wherein the local ID of the first remote UE and the local ID of the second remote UE are used for a user-to-user (U2U) sidelink in a sidelink relay adaptation protocol (SRAP), receive, from a second UE, a data packet with a UE ID, wherein the UE ID includes a destination (DST) UE ID indicating a destination of the data packet and a source (SRC) UE ID indicating a source of the data packet, determine whether the received data packet is an erroneous data packet, based on the identified ID information and the UE ID, and discard the received data packet, in case that the received data is determined as the erroneous data packet.

The present disclosure is defined in the independent claims. Advantageous features are defined in the dependent claims. Embodiments or examples disclosed in the description and/or figures falling outside the scope of the claims are to be understood as examples useful for understanding the present disclosure.

Other aspects, advantages and salient features of the disclosure will become apparent to those skilled in the art from the following detailed description taken in conjunction with the accompanying drawings.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following detailed description taken in conjunction with the accompanying drawings, in which:

FIG. 1 illustrates an exemplary user plane protocol stack for L2 U2U relay according to various embodiments of the present disclosure;

FIG. 2 illustrates an exemplary control plane protocol stack for L2 U2U relay according to various embodiments of the present disclosure;

FIG. 3 illustrates an exemplary network entity according to various embodiments of the present disclosure; and

FIG. 4 illustrates a method according to various embodiments of the present disclosure.

### DETAILED DESCRIPTION

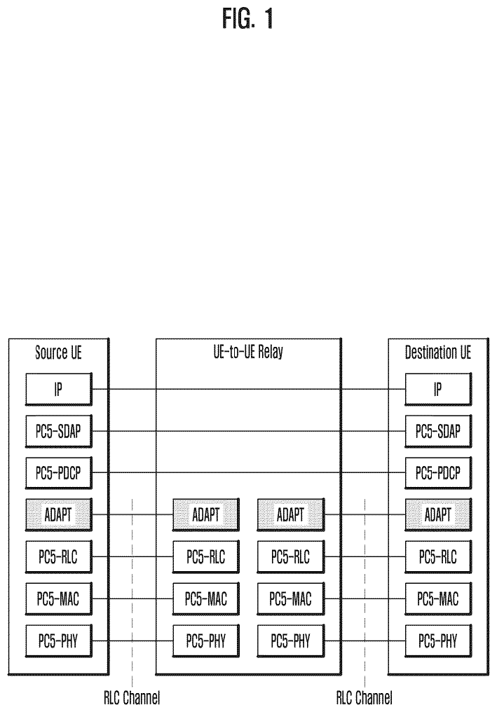

FIG. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following description of examples of the present disclosure, with reference to the accompanying drawings, is provided to assist in a comprehensive understanding of the present disclosure, as defined by the claims. The description includes various specific details to assist in that understanding but these are to be regarded as merely exemplary. Accordingly, those of ordinary skill in the art will recognize that various changes and modifications of the examples described herein can be made without departing from the scope of the disclosure.

The same or similar components may be designated by the same or similar reference numerals, although they may be illustrated in different drawings.

Detailed descriptions of techniques, structures, functions, operations or processes known in the art may be omitted for clarity and conciseness, and to avoid obscuring the subject matter of the present disclosure.

The terms and words used herein are not limited to the bibliographical or standard meanings, but are merely used to enable a clear and consistent understanding of the disclosure.

Throughout the description and claims of this specification, the words “comprise,” “include” and “contain” and variations of the words, for example “comprising” and “comprises,” means “including but not limited to,” and is not intended to (and does not) exclude other features, elements, components, integers, steps, processes, operations, functions, characteristics, properties and/or groups thereof.

Throughout the description and claims of this specification, the singular form, for example “a,” “an” and “the,” encompasses the plural unless the context otherwise requires. For example, reference to “an object” includes reference to one or more of such objects.

Throughout the description and claims of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment, example or claim are to be understood to be applicable to any other aspect, embodiment, example or claim described herein unless incompatible therewith.

The skilled person will appreciate that the techniques described herein may be used in any suitable combination.

Certain examples of the present disclosure provide one or more techniques for handling error cases in U2U Sidelink relay networks, for example in a 3GPP 5G NR network. However, the skilled person will appreciate that the present disclosure is not limited to these examples, and may be applied in any suitable system or standard, for example one or more existing and/or future generation wireless communication systems or standards, including any existing or future releases of the same standards specification, for example 3GPP 5G, 5G-advanced or 6th Generation (6G).

The functionality of the various network entities and other features disclosed herein may be applied to corresponding or equivalent entities or features in the same or any other suitable communication systems or standards. Corresponding or equivalent entities or features may be regarded as entities or features that perform the same or similar role, function or purpose within the network.

For example, the functionality of a base station or the like (e.g., eNB, gNB, NB, RAN node, access point, wireless point, transmission/reception point, central unit, distributed unit, radio unit, remote radio head, etc.) in the examples below may be applied to any other suitable type of entity performing RAN functions, and the functionality of a UE or the like (e.g., electronic device, user device, mobile station, subscriber station, customer premises equipment, terminal, remote terminal, wireless terminal, vehicle terminal, etc.) in the examples below may be applied to any other suitable type of device.

A particular network entity may be implemented as a network element on a dedicated hardware, as a software instance running on a dedicated hardware, and/or as a virtualised function instantiated on an appropriate platform, e.g., on a cloud infrastructure.

The skilled person will appreciate that the present disclosure is not limited to the specific examples disclosed herein. For example:
The techniques disclosed herein are not limited to 3GPP 5G;
One or more entities in the examples disclosed herein may be replaced with one or more alternative entities performing equivalent or corresponding functions, processes or operations;
One or more of the messages in the examples disclosed herein may be replaced with one or more alternative messages, signals or other type of information carriers that communicate equivalent or corresponding information;
One or more further elements or entities may be added to the examples disclosed herein;
One or more non-essential elements or entities may be omitted in certain examples;
The functions, processes or operations of a particular entity in one example may be divided between two or more separate entities in an alternative example;
The functions, processes or operations of two or more separate entities in one example may be performed by a single entity in an alternative example;
Information carried by a particular message in one example may be carried by two or more separate messages in an alternative example;
Information carried by two or more separate messages in one example may be carried by a single message in an alternative example; and
The order in which operations are performed and/or the order in which messages are transmitted may be modified, if possible, in alternative examples.

Certain examples of the present disclosure may be provided in the form of an apparatus/device/network entity configured to perform one or more defined network functions and/or a method therefor. Certain examples of the present disclosure may be provided in the form of a system (e.g., network or wireless communication system) comprising one or more such apparatuses/devices/network entities, and/or a method therefor.

Certain examples of the present disclosure provide a UE, base station (e.g., eNB, gNB) and/or other network entity (e.g., AMF, SMF, etc.) configured to perform a method according to any example, aspect, embodiment and/or claim disclosed herein.

Certain examples of the present disclosure provide a network (or wireless communication system) comprising a UE, base station (e.g., eNB, gNB) and/or other network entity (e.g., AMF, SMF, etc.), according to any examples, aspects, embodiments and/or claims disclosed herein.

Certain examples of the present disclosure provide a computer program comprising instructions which, when the program is executed by a computer or processor, cause the computer or processor to carry out a method according to any example, aspect, embodiment and/or claim disclosed herein.

Certain examples of the present disclosure provide a computer or processor-readable data carrier having stored thereon a computer program according to any example, aspect, embodiment and/or claim disclosed herein.

Certain examples of the present disclosure provide one or more techniques for handling of unknown, unforeseen, and erroneous protocol data. Various examples will now be described in detail. The skilled person will appreciate that the following techniques, and individual features thereof, may be used in any suitable combination.

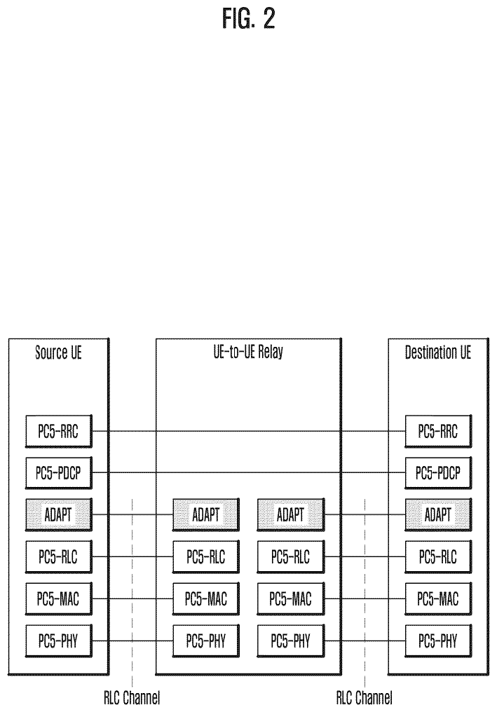

FIG. 1 illustrates an exemplary user plane protocol stack for L2 UE-to-UE (U2U) relay, and FIG. 2 illustrates an exemplary control plane protocol stack for L2 UE-to-UE (U2U) relay.

3GPP agreed to introduce the adapt layer on the PC5 links, as shown in FIGS. 1 and 2 in shaded boxes. The adapt layer is also present on the Uu link, between the relay UE and the gNB (not shown in FIGS. 1 and 2) for L2 UE-to-network (U2N) relay.

For L2 U2N relay, the main agreed functionality of adapt on the Uu link is mapping of UL PC5 bearers onto UL Uu bearers, and performing the inverse process on the DL. The main agreed functionality of adapt on the PC5 link is mapping of DL/UL Uu bearers onto PC5 RLC channels.

This adapt layer was (re)named sidelink relay adaptation protocol, or SRAP for short (TS 38.351). The following is the basic model and operation of SRAP for Rel-17 U2N SL relaying, as agreed by 3GPP:

On the U2N relay UE, the SRAP sublayer contains one SRAP entity at Uu interface and a separate collocated SRAP entity at the PC5 interface. On the U2N remote UE, the SRAP sublayer contains only one SRAP entity at the PC5 interface.

Each SRAP entity has a transmitting part and a receiving part. Across the PC5 interface, the transmitting part of the SRAP entity at the U2N remote UE has a corresponding receiving part of an SRAP entity at the U2N relay UE, and vice-versa. Across the Uu interface, the transmitting part of the SRAP entity at the U2N relay UE has a corresponding receiving part of an SRAP entity at the gNB, and vice-versa.

At the remote UE, in the uplink (UL) direction the SRAP may determine SRAP UE ID and BEARER ID and add the SRAP header. At the remote UE, on the downlink (DL), the SRAP may remove the SRAP header and deliver the packet to higher layers.

At the relay UE, on the UL the SRAP may map the packet from a PC5 channel to a Uu channel using the SRAP UE ID and BEARER ID contained in the packet itself, and the mapping configuration provided by the network. At the relay UE, on the DL the SRAP may map the packet from a Uu channel to a PC5 channel using SRAP UE ID and BEARER ID contained in the packet itself, and the mapping configuration provided by the network.

For Rel-18 L2 UE-to-UE relay, functionalities of the SRAP layer are very similar, with one major difference being that while the identity information of remote UE end-to-end sidelink Radio Bearer is included in the SRAP layer (same as in the U2N case), the identity information of both source remote UE and destination remote UE are included in the SRAP header. Similar to U2N, a new “local” ID is introduced for purposes of SRAP layer addressing.

The initial version of R18 SRAP spec is now available; however, the issue of error handling at SRAP layer is still open for the U2U case.

The above information is presented as background information only to assist with an understanding of the present disclosure. No determination has been made, and no assertion is made, as to whether any of the above might be applicable as prior art with regard to the present disclosure.

### Handling of Error Cases and Misconfiguration at U2U Remote UE

At remote UE, the mapping configuration is provided by its relay UE. The mapping configuration can include sl-RemoteUE-LocalIdentity, sl-RemoteUE-L2Identity, sl-PeerRemoteUE-LocalIdentity, sl-PeerRemoteUE-L2Identity where the 1st two parameters indicate the identifiers for the remote UE itself and the last two parameters indicate the identifiers for the peer remote UE. At remote UE, sl-RemoteUE-SLRB-Identity identifies an end-to-end bearer between the two remote UEs.
At remote UE, if a packet is received with UE ID field for DST UE not matching sl-RemoteUE-LocalIdentity, but UE ID field for SRC UE does match sl-PeerRemoteUE-LocalIdentity, the packet is discarded.
   If a packet is received with UE ID field for DST UE not matching sl-RemoteUE-LocalIdentity, but UE ID field for SRC UE does match sl-PeerRemoteUE-LocalIdentity, the packet is not discarded if sl-PeerRemoteUE-LocalIdentity corresponds to a sl-PeerRemoteUE-L2Identity of one of the peer UEs of the remote UE. In this case, packet is passed on to higher layer entities for said sl-RemoteUE-L2Identity.
At remote UE, if a packet is received with UE ID field for SRC UE not matching sl-PeerRemoteUE-LocalIdentity, but UE ID field for DST UE does match sl-RemoteUE-LocalIdentity, the packet is discarded.
   If a packet is received with UE ID field for SRC UE not matching sl-PeerRemoteUE-LocalIdentity, but UE ID field for DST UE does match sl-RemoteUE-LocalIdentity, the packet is alternatively kept.
At remote UE, if a packet is received with UE ID field for SRC UE not matching sl-PeerRemoteUE-LocalIdentity, and UE ID field for SRC UE not matching sl-RemoteUE-LocalIdentity, the packet is discarded.
At remote UE, if a packet is received with UE ID field for SRC UE matching sl-PeerRemoteUE-LocalIdentity, and UE ID field for DST UE matching sl-RemoteUE-LocalIdentity but whose BEARER ID does not match any sl-RemoteUE-SLRB-Identity configured for that combination of (SRC UE ID, DST UE ID), the packet is discarded.
At remote UE, if a packet is received whose BEARER ID does not match any sl-RemoteUE-SLRB-Identity configured for that UE i.e., any combination of (SRC UE ID, DST UE ID), and the UE ID field for DST UE does not match the sl-RemoteUE-LocalIdentity for that UE, the packet is discarded.
   If a packet is received with UE ID field for DST UE matching sl-RemoteUE-LocalIdentity but whose BEARER ID does not match any sl-RemoteUE-SLRB-Identity configured for that UE i.e., there is no match for any combination of (SRC UE ID, DST UE ID), the packet is not discarded if sl-RemoteUE-SLRB-Identity is not configured.

### Handling of Error Cases and Misconfiguration at U2U Relay UE

At relay UE, if a packet is received with UE ID field for DST UE not matching any sl-RemoteUE-LocalIdentity, but UE ID field for SRC UE does match a sl-PeerRemoteUE-LocalIdentity, the packet is discarded.
At relay UE, if a packet is received with UE ID field for SRC UE not matching any sl-PeerRemoteUE-LocalIdentity, but UE ID field for DST UE does match a sl-RemoteUE-LocalIdentity, the packet is discarded.
   If a packet is received with UE ID field for SRC UE not matching any sl-PeerRemoteUE-LocalIdentity, but UE ID field for DST UE does match a sl-RemoteUE-LocalIdentity, the packet is alternatively kept and the PeerRemoteUE-LocalIdentity is determined as corresponding to sl-PeerRemoteUE-L2Identity of the ingress link is received by U2U relay UE. SRAP header is rewritten so that the SRC UE ID field corresponds to said sl-PeerRemoteUE-LocalIdentity.
At relay UE, if a packet is received with UE ID field for SRC UE not matching any sl-PeerRemoteUE-LocalIdentity in the relay configuration, and UE ID field for DST UE not matching any sl-RemoteUE-LocalIdentity in the relay configuration, the packet is discarded.
At relay UE, if a packet is received whose BEARER ID does not match any sl-RemoteUE-SLRB-Identity configured for any pair of remote UEs, the packet is discarded.
At relay UE, if a packet is received whose BEARER ID does not match any sl-RemoteUE-SLRB-Identity configured for any pair of remote UEs while UE ID field for SRC UE matches any sl-PeerRemoteUE-LocalIdentity in the relay configuration, and UE ID field for DST UE matches any sl-RemoteUE-LocalIdentity in the relay configuration, the packet is not discarded and is forwarded to the DST UE.
At relay UE, if a packet is received whose UE IDs appear in the configuration table but the relevant entries do not match the BEARER ID in the packet, the packet is sent on a default channel. This default channel can be part of the initial relay UE configuration, and can also be re-configurable.
   In an embodiment of this disclosure, the default channel is a dedicated, pre-configured and/or configurable mapping between an RLC channel ID (=the default channel) and one or more E2E bearer IDs (identified by the BEARER ID in the SRAP packet). In a refinement of this embodiment, there is an explicit indication about default channel for this erroneous case to distinguish it from normal use case contained in the E2E bearer<->RLC channel configuration (i.e., relay UE SRAP configuration).

In another example of error handling at U2U relay UE, the configuration at relay UE is given as {SRC L2 ID, src local id, DST L2 ID, dst local id, bearer id for src to dst direction, ingress link, PC5 RLC channel id for src to dst direction ingress link, egress link, PC5 RLC channel id for src to dst direction egress link}, and similarly for the other direction. PC5 RLC channel id for src to dst direction ingress link is optional in this embodiment. Other parameters may be optional elsewhere. Using a specific example: {SRC L2 ID-UE1, local id-ue1, SRC L2 ID-UE2, local id-ue2, bearer #1 for UE1-UE2 PC5 connection, ingress link for UE1-UE2 connection, PC5 RLC channel #A for bearer #1, egress link for UE1-UE2 connection, PC5 RLC channel #B for bearer #1} and {SRC L2 ID-UE2, local-id ue2, SRC L2 ID-UE1, local id ue1, ingress link for UE2-UE1 connection, bearer #1 for UE2-UE1 PC5 connection, egress link for UE2-UE1 connection, PC5 RLC channel #B for bearer #1, PC5 RLC channel #B for bearer #1}. When error related to ingress link (i.e., whether the relevant L2 ID of the ingress link maps to a local ID) is considered, it is checked for the ingress link of each direction i.e., whether the SRC UE ID of the packet matches either local id-ue1 or the concerned local id-ue2 corresponding to the ingress link.

A number of examples of how the existing specification 3GPP TS 38.351 may be modified to incorporate one or more of the above techniques will now be described. In the following examples, additions are indicated with underline.

The skilled person will appreciate that the changes in the following examples may be applied in any suitable combination. For example, a combination of methods for U2U remote UE from Example #i (#i=1, 2, 3, 4, 5, 6, 7 and/or 8) and U2U relay UE from Example #j (#j=1, 2, 3, 4, 5, 6, 7 and/or 8) may be used.

### Example 1

```
-------------------------- 3GPP TS 38.351 Example 1 --------------------------
5.4 Handling of unknown, unforeseen, and erroneous protocol data
For U2N Remote UE, if sl-LocalIdentity and sl-RemoteUE-RB-Identity are both
configured, when a SRAP Data PDU with SRAP header that contains a UE ID field or
BEARER ID field which does not match sl-LocalIdentity or sl-RemoteUE-RB-Identity
included in sl-SRAP-ConfigRemote is received, the SRAP entity shall:
  - discard the received SRAP Data PDU.
For U2U Remote UE, if sl-RemoteUE-LocalIdentity, sl-PeerRemote UE-LocalIdentity, and
sl-RemoteUE-SLRB-Identity are all configured, when a SRAP Data PDU with SRAP
header that contains a DST UE ID field which does not match sl-RemoteUE-LocalIdentity
or a SRC UE ID field which does not match sl-PeerRemoteUE-LocalIdentity included in
sl-SRAP-ConfigPC5 or BEARER ID field which does not match sl-RemoteUE-SLRB-
Identity included in sl-SRAP-ConfigU2U is received from a U2U Relay UE, the SRAP
entity shall:
  - discard the received SRAP Data PDU.
For U2N Relay UE, when a SRAP Data PDU with SRAP header that contains a UE ID
field or BEARER ID field which does not match sl-LocalIdentity or sl-RemoteUE-RB-
Identity included in sl-SRAP-ConfigRelay is received except in the case where the SRAP
Data PDU from SL-RLC1 as specified in TS 38.331 [3] is the first SRAP Data PDU
received from a U2N Remote UE, or when a SRAP Data PDU that contains a UE ID which
does not match the concerned sl-LocalIdentity corresponding to sl-L2IdentityRemote of the
ingress link is received by U2N Relay UE, the SRAP entity shall:
  - discard the received SRAP Data PDU.
For U2U Relay UE, when a SRAP Data PDU with SRAP header that contains a DST UE
ID field or SRC UE ID field or BEARER ID field which does not match sl-RemoteUE-
LocalIdentity, sl-PeerRemoteUE-LocalIdentity, and sl-RemoteUE-SLRB-Identity included
in sl-SRAP-ConfigPC5 and sl-SRAP-ConfigU2U is received, or when a SRAP Data PDU
that contains a SRC UE ID which does not match the concerned sl-PeerRemoteUE-
LocalIdentity corresponding to sl-L2IdentityRemote of the ingress link is received by U2U
Relay UE, the SRAP entity shall:
  - discard the received SRAP Data PDU.
When any of the U2N Remote UE, the U2N Relay UE, the U2U Remote UE or the U2U
Relay UE receives a SRAP PDU with invalid or reserved values, the SRAP entity shall:
  - discard the received SRAP PDU.
-------------------------- 3GPP TS 38.351 Example 1 --------------------------
```

### Example 2: No Discarding at U2U Remote UE When Only SRC UE ID is Not a Match, so Long as Corresponding sl-PeerRemoteUE-LocalIdentity Matches One of the Peer UEs

```
-------------------------- 3GPP TS 38.351 Example 2 --------------------------
5.4 Handling of unknown, unforeseen, and erroneous protocol data
For U2N Remote UE, if sl-LocalIdentity and sl-RemoteUE-RB-Identity are both
configured, when a SRAP Data PDU with SRAP header that contains a UE ID field or
BEARER ID field which does not match sl-LocalIdentity or sl-Remote UE-RB-Identity
included in sl-SRAP-ConfigRemote is received, the SRAP entity shall:
  - discard the received SRAP Data PDU.
For U2U Remote UE, if sl-RemoteUE-LocalIdentity, sl-PeerRemoteUE-LocalIdentity, and
sl-RemoteUE-SLRB-Identity are all configured, when a SRAP Data PDU with SRAP
header that contains a DST UE ID field which does not match sl-RemoteUE-LocalIdentity
included in sl-SRAP-ConfigPC5 and sl-PeerRemoteUE-LocalIdentity does not correspond
to sl-L2IdentityRemote of one of the peer UEs of the U2U Remote UE, or a SRC UE ID
field which does not match sl-PeerRemoteUE-LocalIdentity included in sl-SRAP-
ConfigPC5 and sl-PeerRemoteUE-LocalIdentity does not correspond to sl-
L2IdentityRemote of one of the peer UEs of the U2U Remote UE, or BEARER ID field
which does not match sl-RemoteUE-SLRB-Identity included in sl-SRAP-ConfigU2U is
received from a U2U Relay UE, or the SRAP entity shall:
  - discard the received SRAP Data PDU.
For U2N Relay UE, when a SRAP Data PDU with SRAP header that contains a UE ID
field or BEARER ID field which does not match sl-LocalIdentity or sl-RemoteUE-RB-
Identity included in sl-SRAP-ConfigRelay is received except in the case where the SRAP
Data PDU from SL-RLC1 as specified in TS 38.331 [3] is the first SRAP Data PDU
received from a U2N Remote UE, or when a SRAP Data PDU that contains a UE ID which
does not match the concerned sl-LocalIdentity corresponding to sl-L2IdentityRemote of the
ingress link is received by U2N Relay UE, the SRAP entity shall:
  - discard the received SRAP Data PDU.
For U2U Relay UE, when a SRAP Data PDU with SRAP header that contains a DST UE
ID field or SRC UE ID field or BEARER ID field which does not match sl-RemoteUE-
LocalIdentity, sl-PeerRemoteUE-LocalIdentity, and sl-RemoteUE-SLRB-Identity included
in sl-SRAP-ConfigPC5 and sl-SRAP-ConfigU2U is received, or when a SRAP Data PDU
that contains a SRC UE ID which does not match the concerned sl-RemoteUE-
LocalIdentity corresponding to sl-L2IdentityRemote of the ingress link is received by U2U
Relay UE, the SRAP entity shall:
  - discard the received SRAP Data PDU.
When any of the U2N Remote UE, the U2N Relay UE, the U2U Remote UE or the U2U
Relay UE receives a SRAP PDU with invalid or reserved values, the SRAP entity shall:
  - discard the received SRAP PDU.
-------------------------- 3GPP TS 38.351 Example 2 --------------------------
```

### Example 3: No Discarding at U2U Relay UE When Only SRC UE ID is Not a Match

```
-------------------------- 3GPP TS 38.351 Example 3 --------------------------
5.4 Handling of unknown, unforeseen, and erroneous protocol data
For U2N Remote UE, if sl-LocalIdentity and sl-RemoteUE-RB-Identity are both
configured, when a SRAP Data PDU with SRAP header that contains a UE ID field or
BEARER ID field which does not match sl-LocalIdentity or sl-Remote UE-RB-Identity
included in sl-SRAP-ConfigRemote is received, the SRAP entity shall:
  - discard the received SRAP Data PDU.
For U2U Remote UE, if sl-RemoteUE-LocalIdentity, sl-PeerRemote UE-LocalIdentity, and
sl-RemoteUE-SLRB-Identity are all configured, when a SRAP Data PDU with SRAP
header that contains a DST UE ID field which does not match sl-RemoteUE-LocalIdentity
or a SRC UE ID field which does not match sl-PeerRemoteUE-LocalIdentity included in
sl-SRAP-ConfigPC5 or BEARER ID field which does not match sl-RemoteUE-SLRB-
Identity included in sl-SRAP-ConfigU2U is received from a U2U Relay UE, the SRAP
entity shall:
  - discard the received SRAP Data PDU.
For U2N Relay UE, when a SRAP Data PDU with SRAP header that contains a UE ID
field or BEARER ID field which does not match sl-LocalIdentity or sl-Remote UE-RB-
Identity included in sl-SRAP-ConfigRelay is received except in the case where the SRAP
Data PDU from SL-RLC1 as specified in TS 38.331 [3] is the first SRAP Data PDU
received from a U2N Remote UE, or when a SRAP Data PDU that contains a UE ID which
does not match the concerned sl-LocalIdentity corresponding to sl-L2IdentityRemote of the
ingress link is received by U2N Relay UE, the SRAP entity shall:
  - discard the received SRAP Data PDU.
For U2U Relay UE, when a SRAP Data PDU with SRAP header that contains a DST UE
ID field or SRC UE ID field or BEARER ID field which does not match sl-RemoteUE-
LocalIdentity, sl-PeerRemoteUE-LocalIdentity, and sl-RemoteUE-SLRB-Identity included
in sl-SRAP-ConfigPC5 and sl-SRAP-ConfigU2U is received, or when a SRAP Data PDU
that contains a SRC UE ID which does not match the concerned sl-RemoteUE-
LocalIdentity corresponding to sl-L2IdentityRemote of the ingress link is received by U2U
Relay UE, the SRAP entity shall:
  - discard the received SRAP Data PDU.
For U2U Relay UE, when a SRAP Data PDU with SRAP header that contains a SRC UE
ID field which does not match sl-PeerRemoteUE-LocalIdentity included in sl-SRAP-
ConfigPC5 and DST UE ID field and BEARER ID field which match sl-RemoteUE-
LocalIdentity and sl-RemoteUE-SLRB-Identity included in sl-SRAP-ConfigPC5 and sl-
SRAP-ConfigU2U is received, the SRAP entity shall:
  - rewrite the SRAP header so that the SRC UE ID field matches sl-RemoteUE-
      LocalIdentity corresponding to sl-L2IdentityRemote of the ingress link and forward
      the SRAP Data PDU to the DST UE ID.
When any of the U2N Remote UE, the U2N Relay UE, the U2U Remote UE or the U2U
Relay UE receives a SRAP PDU with invalid or reserved values, the SRAP entity shall:
  - discard the received SRAP PDU.
-------------------------- 3GPP TS 38.351 Example 3 --------------------------
```

### Example 4: No Discarding at U2U Relay UE When Only BEARER ID is Not a Match

```
-------------------------- 3GPP TS 38.351 Example 4 --------------------------
5.4 Handling of unknown, unforeseen, and erroneous protocol data
For U2N Remote UE, if sl-LocalIdentity and sl-RemoteUE-RB-Identity are both
configured, when a SRAP Data PDU with SRAP header that contains a UE ID field or
BEARER ID field which does not match sl-LocalIdentity or sl-Remote UE-RB-Identity
included in sl-SRAP-ConfigRemote is received, the SRAP entity shall:
  - discard the received SRAP Data PDU.
For U2U Remote UE, if sl-RemoteUE-LocalIdentity, sl-PeerRemoteUE-LocalIdentity, and
sl-RemoteUE-SLRB-Identity are all configured, when a SRAP Data PDU with SRAP
header that contains a DST UE ID field which does not match sl-RemoteUE-LocalIdentity
or a SRC UE ID field which does not match sl-PeerRemoteUE-LocalIdentity included in
sl-SRAP-ConfigPC5 or BEARER ID field which does not match sl-RemoteUE-SLRB-
Identity included in sl-SRAP-ConfigU2U is received from a U2U Relay UE, the SRAP
entity shall:
  - discard the received SRAP Data PDU.
For U2N Relay UE, when a SRAP Data PDU with SRAP header that contains a UE ID
field or BEARER ID field which does not match sl-LocalIdentity or sl-RemoteUE-RB-
Identity included in sl-SRAP-ConfigRelay is received except in the case where the SRAP
Data PDU from SL-RLC1 as specified in TS 38.331 [3] is the first SRAP Data PDU
received from a U2N Remote UE, or when a SRAP Data PDU that contains a UE ID which
does not match the concerned sl-LocalIdentity corresponding to sl-L2IdentityRemote of the
ingress link is received by U2N Relay UE, the SRAP entity shall:
  - discard the received SRAP Data PDU.
For U2U Relay UE, when a SRAP Data PDU with SRAP header that contains a DST UE
ID field or SRC UE ID field or BEARER ID field which does not match sl-RemoteUE-
LocalIdentity, sl-PeerRemoteUE-LocalIdentity, and sl-RemoteUE-SLRB-Identity included
in sl-SRAP-ConfigPC5 and sl-SRAP-ConfigU2U is received, or when a SRAP Data PDU
that contains a SRC UE ID which does not match the concerned sl-RemoteUE-
LocalIdentity corresponding to sl-L2IdentityRemote of the ingress link is received by U2U
Relay UE, the SRAP entity shall:
  - discard the received SRAP Data PDU.
For U2U Relay UE, when a SRAP Data PDU with SRAP header that contains a DST UE
ID field and SRC UE ID field matching respectively sl-RemoteUE-LocalIdentity and sl-
PeerRemoteUE-LocalIdentity included in sl-SRAP-ConfigPC5, and a BEARER ID which
does not match sl-RemoteUE-SLRB-Identity included in sl-SRAP-ConfigPC5, the SRAP
entity shall:
  - forward the SRAP Data PDU to the DST Remote UE.
When any of the U2N Remote UE, the U2N Relay UE, the U2U Remote UE or the U2U
Relay UE receives a SRAP PDU with invalid or reserved values, the SRAP entity shall:
  - discard the received SRAP PDU.
-------------------------- 3GPP TS 38. 351 Example 4 --------------------------
```

### Example 5: Discarding at U2U Relay UE When SRC UE ID or DST UE ID Do Not Match Relevant sl-L2IdentityRemote/sl-SourceUE-Identity, Regardless of BEARER ID

```
-------------------------- 3GPP TS 38.351 Example 5 --------------------------
5.4 Handling of unknown, unforeseen, and erroneous protocol data
For U2N Remote UE, if sl-LocalIdentity and sl-RemoteUE-RB-Identity are both
configured, when a SRAP Data PDU with SRAP header that contains a UE ID field or
BEARER ID field which does not match sl-LocalIdentity or sl-Remote UE-RB-Identity
included in sl-SRAP-ConfigRemote is received, the SRAP entity shall:
  - discard the received SRAP Data PDU.
For U2U Remote UE, if sl-RemoteUE-LocalIdentity, sl-PeerRemoteUE-LocalIdentity, and
sl-RemoteUE-SLRB-Identity are all configured, when a SRAP Data PDU with SRAP
header that contains a DST UE ID field which does not match sl-RemoteUE-LocalIdentity
or a SRC UE ID field which does not match sl-PeerRemoteUE-LocalIdentity included in
sl-SRAP-ConfigPC5 or BEARER ID field which does not match sl-RemoteUE-SLRB-
Identity included in sl-SRAP-ConfigU2U is received from a U2U Relay UE, the SRAP
entity shall:
  - discard the received SRAP Data PDU.
For U2N Relay UE, when a SRAP Data PDU with SRAP header that contains a UE ID
field or BEARER ID field which does not match sl-LocalIdentity or sl-Remote UE-RB-
Identity included in sl-SRAP-ConfigRelay is received except in the case where the SRAP
Data PDU from SL-RLC1 as specified in TS 38.331 [3] is the first SRAP Data PDU
received from a U2N Remote UE, or when a SRAP Data PDU that contains a UE ID which
does not match the concerned sl-LocalIdentity corresponding to sl-L2IdentityRemote of the
ingress link is received by U2N Relay UE, the SRAP entity shall:
  - discard the received SRAP Data PDU.
For U2U Relay UE, when a SRAP Data PDU with SRAP header that contains a DST UE
ID field or SRC UE ID field or BEARER ID field which does not match sl-RemoteUE-
LocalIdentity, sl-PeerRemoteUE-LocalIdentity, and sl-RemoteUE-SLRB-Identity included
in sl-SRAP-ConfigPC5 and sl-SRAP-ConfigU2U is received, or when a SRAP Data PDU
that contains a SRC UE ID which does not match the concerned sl-PeerRemoteUE-
LocalIdentity corresponding to sl-SourceUE-Identity of the ingress link is received by U2U
Relay UE, or when a SRAP Data PDU that contains a DST UE ID which does not match
the concerned sl-RemoteUE-LocalIdentity corresponding to sl-L2IdentityRemote of any of
the egress links is received by U2U Relay UE, the SRAP entity shall:
  - discard the received SRAP Data PDU.
When any of the U2N Remote UE, the U2N Relay UE, the U2U Remote UE or the U2U
Relay UE receives a SRAP PDU with invalid or reserved values, the SRAP entity shall:
  - discard the received SRAP PDU.
-------------------------- 3GPP TS 38.351 Example 5 --------------------------
```

### Example 6: Discarding at U2U Relay UE When SRC UE ID or DST UE ID Do Not Match Relevant sl-L2IdentityRemote/sl-SourceUE-Identity or sl-SourceUE-Identity/sl-L2IdentityRemote, Regardless of BEARER ID

```
-------------------------- 3GPP TS 38.351 Example 6 --------------------------
5.4 Handling of unknown, unforeseen, and erroneous protocol data
For U2N Remote UE, if sl-LocalIdentity and sl-RemoteUE-RB-Identity are both
configured, when a SRAP Data PDU with SRAP header that contains a UE ID field or
BEARER ID field which does not match sl-LocalIdentity or sl-RemoteUE-RB-Identity
included in sl-SRAP-ConfigRemote is received, the SRAP entity shall:
  - discard the received SRAP Data PDU.
For U2U Remote UE, if sl-RemoteUE-LocalIdentity, sl-PeerRemoteUE-LocalIdentity, and
sl-RemoteUE-SLRB-Identity are all configured, when a SRAP Data PDU with SRAP
header that contains a DST UE ID field which does not match sl-RemoteUE-LocalIdentity
or a SRC UE ID field which does not match sl-PeerRemoteUE-LocalIdentity included in
sl-SRAP-ConfigPC5 or BEARER ID field which does not match sl-RemoteUE-SLRB-
Identity included in sl-SRAP-ConfigU2U is received from a U2U Relay UE, the SRAP
entity shall:
  - discard the received SRAP Data PDU.
For U2N Relay UE, when a SRAP Data PDU with SRAP header that contains a UE ID
field or BEARER ID field which does not match sl-LocalIdentity or sl-Remote UE-RB-
Identity included in sl-SRAP-ConfigRelay is received except in the case where the SRAP
Data PDU from SL-RLC1 as specified in TS 38.331 [3] is the first SRAP Data PDU
received from a U2N Remote UE, or when a SRAP Data PDU that contains a UE ID which
does not match the concerned sl-LocalIdentity corresponding to sl-L2IdentityRemote of the
ingress link is received by U2N Relay UE, the SRAP entity shall:
  - discard the received SRAP Data PDU.
For U2U Relay UE, when a SRAP Data PDU with SRAP header that contains a DST UE
ID field or SRC UE ID field or BEARER ID field which does not match sl-RemoteUE-
LocalIdentity, sl-PeerRemoteUE-LocalIdentity, and sl-RemoteUE-SLRB-Identity included
in sl-SRAP-ConfigPC5 and sl-SRAP-ConfigU2U is received, or when a SRAP Data PDU
that contains a SRC UE ID which does not match the concerned sl-PeerRemoteUE-
LocalIdentity corresponding to sl-L2IdentityRemote of the ingress link is received by U2U
Relay UE, or when a SRAP Data PDU that contains a SRC UE ID which does not match
the concerned sl-Remote UE-LocalIdentity corresponding to sl-L2IdentityRemote of the
ingress link, the SRAP entity shall:
  - discard the received SRAP Data PDU.
When any of the U2N Remote UE, the U2N Relay UE, the U2U Remote UE or the U2U
Relay UE receives a SRAP PDU with invalid or reserved values, the SRAP entity shall:
  - discard the received SRAP PDU.
-------------------------- 3GPP TS 38.351 Example 6 --------------------------
```

### Example 7

```
-------------------------- 3GPP TS 38.351 Example 7 --------------------------
5.4 Handling of unknown, unforeseen, and erroneous protocol data
For U2N Remote UE, if sl-LocalIdentity and sl-RemoteUE-RB-Identity are both
configured, when a SRAP Data PDU with SRAP header that contains a UE ID field or
BEARER ID field which does not match sl-LocalIdentity or sl-RemoteUE-RB-Identity
included in sl-SRAP-ConfigRemote is received, the SRAP entity shall:
  - discard the received SRAP Data PDU.
For U2U Remote UE, if sl-RemoteUE-LocalIdentity, sl-PeerRemote UE-LocalIdentity, and
sl-RemoteUE-SLRB-Identity are all configured, when a SRAP Data PDU with SRAP
header that contains a DST UE ID field which does not match sl-RemoteUE-LocalIdentity
or a SRC UE ID field which does not match sl-PeerRemoteUE-LocalIdentity included in
sl-SRAP-ConfigPC5 or BEARER ID field which does not match sl-RemoteUE-SLRB-
Identity included in sl-SRAP-ConfigU2U is received from a U2U Relay UE, the SRAP
entity shall:
  - discard the received SRAP Data PDU.
For U2N Relay UE, when a SRAP Data PDU with SRAP header that contains a UE ID
field or BEARER ID field which does not match sl-LocalIdentity or sl-Remote UE-RB-
Identity included in sl-SRAP-ConfigRelay is received except in the case where the SRAP
Data PDU from SL-RLC1 as specified in TS 38.331 [3] is the first SRAP Data PDU
received from a U2N Remote UE, or when a SRAP Data PDU that contains a UE ID which
does not match the concerned sl-LocalIdentity corresponding to sl-L2IdentityRemote of the
ingress link is received by U2N Relay UE, the SRAP entity shall:
  - discard the received SRAP Data PDU.
For U2U Relay UE, when a SRAP Data PDU with SRAP header that contains a DST UE
ID field or SRC UE ID field or BEARER ID field which does not match sl-RemoteUE-
LocalIdentity, sl-PeerRemoteUE-LocalIdentity, and sl-RemoteUE-SLRB-Identity included
in sl-SRAP-ConfigPC5 and sl-SRAP-ConfigU2U is received, or when a SRAP Data PDU
that contains a SRC UE ID which does not match the concerned sl-PeerRemoteUE-
LocalIdentity corresponding to sl-SourceUE-Identity of the ingress link is received by U2U
Relay UE, or when a SRAP Data PDU that contains a DST UE ID which does not match
the concerned sl-RemoteUE-LocalIdentity corresponding to sl-L2IdentityRemote of any of
the egress links is received by U2U Relay UE, or when a SRAP Data PDU that contains a
SRC UE ID which does not match the concerned sl-RemoteUE-LocalIdentity
corresponding to sl-SourceUE-Identity of the ingress link is received by U2U Relay UE, or
when a SRAP Data PDU that contains a DST UE ID which does not match the concerned
sl-PeerRemoteUE-LocalIdentity corresponding to sl-L2IdentityRemote of any of the egress
links is received by U2U Relay UE, the SRAP entity shall:
  - discard the received SRAP Data PDU.
When any of the U2N Remote UE, the U2N Relay UE, the U2U Remote UE or the U2U
Relay UE receives a SRAP PDU with invalid or reserved values, the SRAP entity shall:
  - discard the received SRAP PDU.
-------------------------- 3GPP TS 38.351 Example 7 --------------------------
```

### Example 8

```
-------------------------- 3GPP TS 38.351 Example 8 --------------------------
5.4 Handling of unknown, unforeseen, and erroneous protocol data
For U2N Remote UE, if sl-LocalIdentity and sl-RemoteUE-RB-Identity are both
configured, when a SRAP Data PDU with SRAP header that contains a UE ID field or
BEARER ID field which does not match sl-LocalIdentity or sl-RemoteUE-RB-Identity
included in sl-SRAP-ConfigRemote is received, the SRAP entity shall:
  - discard the received SRAP Data PDU.
For U2U Remote UE, if sl-RemoteUE-LocalIdentity, sl-PeerRemoteUE-LocalIdentity, and
sl-RemoteUE-SLRB-Identity are all configured, when a SRAP Data PDU with SRAP
header that contains a DST UE ID field which does not match sl-RemoteUE-LocalIdentity
or a SRC UE ID field which does not match sl-PeerRemoteUE-LocalIdentity included in
sl-SRAP-ConfigPC5 or BEARER ID field which does not match sl-RemoteUE-SLRB-
Identity included in sl-SRAP-ConfigU2U is received from a U2U Relay UE, the SRAP
entity shall:
  - discard the received SRAP Data PDU.
For U2N Relay UE, when a SRAP Data PDU with SRAP header that contains a UE ID
field or BEARER ID field which does not match sl-LocalIdentity or sl-RemoteUE-RB-
Identity included in sl-SRAP-ConfigRelay is received except in the case where the SRAP
Data PDU from SL-RLC1 as specified in TS 38.331 [3] is the first SRAP Data PDU
received from a U2N Remote UE, or when a SRAP Data PDU that contains a UE ID which
does not match the concerned sl-LocalIdentity corresponding to sl-L2IdentityRemote of the
ingress link is received by U2N Relay UE, the SRAP entity shall:
  - discard the received SRAP Data PDU.
For U2U Relay UE, when a SRAP Data PDU with SRAP header that contains a DST UE
ID field or SRC UE ID field or BEARER ID field which does not match sl-RemoteUE-
LocalIdentity, sl-PeerRemoteUE-LocalIdentity, and sl-RemoteUE-SLRB-Identity included
in sl-SRAP-ConfigPC5 and sl-SRAP-ConfigU2U is received, or when a SRAP Data PDU
that contains a SRC UE ID which does not match either the concerned sl-RemoteUE-
LocalIdentity or the concerned sl-PeerRemoteUE-LocalIdentity corresponding to the
ingress link is received by U2U Relay UE, the SRAP entity shall:
  - discard the received SRAP Data PDU.
When any of the U2N Remote UE, the U2N Relay UE, the U2U Remote UE or the U2U
Relay UE receives a SRAP PDU with invalid or reserved values, the SRAP entity shall:
  - discard the received SRAP PDU.
-------------------------- 3GPP TS 38.351 Example 8 --------------------------
```

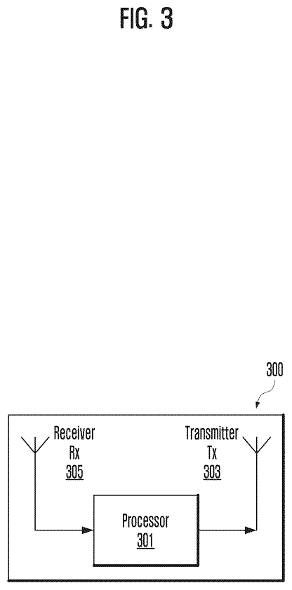

FIG. 3 illustrates an exemplary network entity according to various embodiment of the present disclosure.

For example, a UE in the examples of FIGS. 1 and 2 may comprise an entity of FIG. 3. The skilled person will appreciate that a network entity may be implemented, for example, as a network element on a dedicated hardware, as a software instance running on a dedicated hardware, and/or as a virtualised function instantiated on an appropriate platform, e.g., on a cloud infrastructure.

The entity 300 comprises a processor (or controller) 301, a transmitter 303 and a receiver 305. The receiver 305 is configured for receiving one or more messages from one or more other network entities, for example as described above. The transmitter 303 is configured for transmitting one or more messages to one or more other network entities, for example as described above. The processor 301 is configured for performing one or more operations, for example according to the operations as described above.

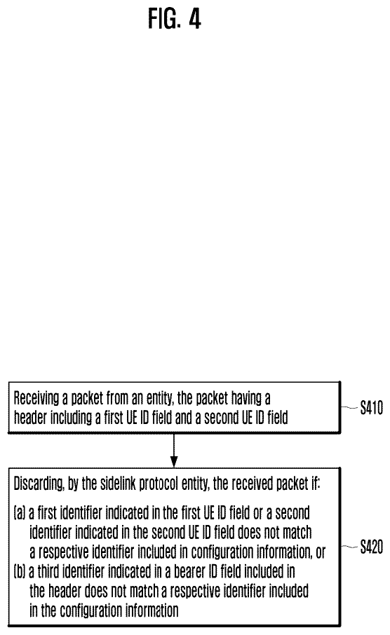

FIG. 4 illustrates a method according to various embodiments of the present disclosure.

The method involves (e.g., is performed by, is at least partly performed by, or is at least performed by a component or entity thereof) a UE in a sidelink relay network, where a sidelink relay protocol entity (e.g., SRAP entity) is configured for the UE.

In operation S410, the UE receives a packet from an entity, the packet having a header including a first UE ID field and a second UE ID field.

In operation S420, the sidelink protocol entity discards the received packet if: (a) a first identifier indicated in the first UE ID field or a second identifier indicated in the second UE ID field does not match a respective identifier included in configuration information, or (b) a third identifier indicated in a bearer ID field included in the header does not match a respective identifier included in the configuration information.

In various examples, the method may also include one or more of the operations/features set out in the appended claims.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

While the disclosure has been shown and described with reference to certain examples, it will be understood by those skilled in the art that various changes in form and detail may be made therein without departing from the scope of the disclosure, as defined by the appended claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a first user equipment (UE) in a wireless communication system, the method comprising:
identifying identification (ID) information including a local ID of a first remote UE and a local ID of a second remote UE, wherein the local ID of the first remote UE and the local ID of the second remote UE are used for a user-to-user (U2U) sidelink in a sidelink relay adaptation protocol (SRAP);
receiving, from a second UE, a data packet with a UE ID, wherein the UE ID includes a destination (DST) UE ID indicating a destination of the data packet and a source (SRC) UE ID indicating a source of the data packet;
determining whether the received data packet is an erroneous data packet, based on the identified ID information and the UE ID; and
discarding the received data packet, in case that the received data is determined as the erroneous data packet.

2. The method of claim 1, wherein the ID information further includes a layer-2 ID of the first remote UE and a layer-2 ID of the second remote UE.

3. The method of claim 1, further comprising:
identifying bearer information on a data radio bearer (DRB) configuration ID used for the U2U sidelink,
wherein the received data packet includes a bearer ID used for identifying end-to-end bearer between the first remote UE and the second remote UE, and
wherein in case that the bearer ID does not match the DRB configuration ID, the received data packet is determined as the erroneous data packet.

4. The method of claim 1, further comprising:
receiving, from the second UE, the ID information,
wherein the first UE is the first remote UE, and
wherein the second UE is a relay UE.

5. The method of claim 4, wherein in case that the UE ID does not match at least one of the local ID of the first remote UE and the local ID of the second remote UE, the received data packet is determined as the erroneous data packet.

6. The method of claim 1, further comprising:
transmitting, to the second UE, the ID information,
wherein the first UE is a relay UE, and
wherein the second UE is the second remote UE.

7. The method of claim 6, wherein in case that the DST UE ID does not match the local ID of the first remote UE, the received data packet is determined as the erroneous data packet.

8. The method of claim 6, wherein in case that the SRC UE ID does not match the local ID of the second remote UE, the received data packet is determined as the erroneous data packet,
wherein the local ID of the second remote UE corresponds to a layer-2 ID of the second remote UE, the layer-2 ID being further included in the ID information, and
wherein an ingress link of the first UE corresponds to the layer-2 ID.

9. A first user equipment (UE) in a wireless communication system, the first UE comprising:
a transceiver; and
a processor coupled with the transceiver and configured to:
identify identification (ID) information including a local ID of a first remote UE and a local ID of a second remote UE, wherein the local ID of the first remote UE and the local ID of the second remote UE are used for a user-to-user (U2U) sidelink in a sidelink relay adaptation protocol (SRAP),
receive, from a second UE, a data packet with a UE ID, wherein the UE ID includes a destination (DST) UE ID indicating a destination of the data packet and a source (SRC) UE ID indicating a source of the data packet,
determine whether the received data packet is an erroneous data packet, based on the identified ID information and the UE ID, and
discard the received data packet, in case that the received data is determined as the erroneous data packet.

10. The first UE of claim 9, wherein the ID information further includes a layer-2 ID of the first remote UE and a layer-2 ID of the second remote UE.

11. The first UE of claim 9, wherein the processor is further configured to identify bearer information on a data radio bearer (DRB) configuration ID used for the U2U sidelink,
wherein the received data packet includes a bearer ID used for identifying end-to-end bearer between the first remote UE and the second remote UE, and
wherein in case that the bearer ID does not match the DRB configuration ID, the received data packet is determined as the erroneous data packet.

12. The first UE of claim 9, wherein the processor is further configured to receive, from the second UE, the ID information,
wherein the first UE is the first remote UE, and
wherein the second UE is a relay UE.

13. The first UE of claim 12, wherein in case that the UE ID does not match at least one of the local ID of the first remote UE and the local ID of the second remote UE, the received data packet is determined as the erroneous data packet.

14. The first UE of claim 9, wherein the processor is further configured to transmit, to the second UE, the ID information,
wherein the first UE is a relay UE, and
wherein the second UE is the second remote UE.

15. The first UE of claim 14, wherein in case that the DST UE ID does not match the local ID of the first remote UE, the received data packet is determined as the erroneous data packet,
wherein in case that the SRC UE ID does not match the local ID of the second remote UE, the received data packet is determined as the erroneous data packet,
wherein the local ID of the second remote UE corresponds to a layer-2 ID of the second remote UE, the layer-2 ID being further included in the ID information, and
wherein an ingress link of the first UE corresponds to the layer-2 ID.
